(19) United States
(12) Patent Application Publication
(10) Pub. No.: US 2016/0209559 A1
(43) Pub. Date: Jul. 21, 2016

(54) PAVEMENT MARKING TAPE INCORPORATING ADVANCED MATERIALS FOR IMPROVED VISIBILITY

(71) Applicant: Brite-Line Technologies, LLC, Canton, MA (US)

(72) Inventors: Wil McCarthy, Lakewood, CO (US); Kevin H. White, Denver, CO (US); Gordon Sill, Monument, CO (US)

(21) Appl. No.: 15/002,153

(22) Filed: Jan. 20, 2016

Related U.S. Application Data
(60) Provisional application No. 62/105,599, filed on Jan. 20, 2015.

(51) Int. Cl. G02B 5/128; G06K 19/07; C09J 7/02; G02B 27/14

(52) U.S. Cl. CPC G02B 5/128; G02B 27/141; G06K 19/0723; C09J 7/026; C09J 2201/16; C09J 2201/32; C09J 2205/106; C08K 3/04

(57) ABSTRACT

A pavement marking tape has visibility-enhancing features for both humans and machines, including high-index-of-refraction reflective elements, quantum emitters, dichroic pigments, and passive, machine-readable emitting tags (e.g., RFID tags).

### CROSS-REFERENCE TO RELATED APPLICATION

This application claims priority under 35 U.S.C. §119 to Provisional Application No. 62/105,599, filed Jan. 20, 2015, entitled “Pavement marking tape incorporating advanced materials for improved visibility,” the entire contents of which are incorporated herein by reference.

### BACKGROUND

1. Technical Field

The subject matter described herein relates to retroreflective pavement marking tapes incorporating advanced materials for improved nighttime visibility.

2. Background

The idea of marking pavement using retroreflective tapes (whether durable/permanent or removable) has a long history, dating back to at least the mid-1970s when multilayered, retroreflective laminate materials intended to be used for road and highway marking, among other applications, were developed. Although they may have incorporated some crowning (i.e., thicker in the middle than along the edges), these tapes were generally flat. However, in the early 1990s a series of pavement marking tapes were developed that had raised, regularly spaced, embossed features intended to improve retroreflectivity by placing the reflective elements (generally, microscopic glass beads) on the vertical faces of the raised bosses or bumps, rather than on a uniform horizontal surface.

The raised features also provide drainage during rain, and delay the moment when the tape is completely covered under conditions of snow or minor flooding. Furthermore, because the retroreflective elements are on the vertical rather than the horizontal faces, they are somewhat better protected from mechanical abuse due to tire hits and snow plows.

During the 1990s it was noticed that with this plurality of regularly spaced and closely packed features, there is a shadowing or interference effect wherein each raised bump blocks the view of the ones behind it. Thus, for any given viewing angle some bumps are “wasted” in the sense that they do not contribute to overall reflectivity, and can even detract from it.

A final problem with pavement marking tapes is their visibility in darkness under wet conditions. A primary mechanism of visibility is the retroreflectivity of glass or ceramic beads. In general, when light traveling through the air (with an index of refraction of approximately 1.0) strikes a glass bead (e.g., normal soda-lime glass with an index of refraction of approximately 1.5), there is a refraction mismatch between the bead and the air which causes a certain amount of light striking the bead to be reflected. However, because the bead is convex with respect to the light, this reflection is scattered in all directions. However, the remainder of the light striking the bead then travels into and through the bead, and if it encounters a second refraction mismatch at the “back” side of the bead, the surface at this point is concave with respect to the light, and thus will focus and reflect the light back in the direction of its origin, a property known as “retroreflection.” Thus, when the headlights of an approaching vehicle strike the pavement marking tape, a substantial reflection is returned toward the vehicle's driver (or in the case of an autonomous vehicle, its navigation cameras).

However, if the bead is covered by rainwater (index of refraction 1.333), then the refraction mismatch between the bead and its surrounding medium is significantly reduced, and the resulting decrease in retroreflectivity may make it insufficient for nighttime road safety. Therefore, “wet reflective” elements of doped glass or other ceramics may be employed which have a significantly higher index of refraction, with n=1.7 and n=1.9 materials being the most common, and materials with n>2.0 being less common and more expensive. These high-index reflective elements may be monolithic microbeads, or they may consist of smaller high-index particles formed into clusters or else attached to a larger carrier particle. Such “wet reflective” tapes represent the current state of the art.

The information included in this Background section of the specification, including any references cited herein and any description or discussion thereof, is included for technical reference purposes only and is not to be regarded as subject matter by which the scope of the claims is to be bound.

### SUMMARY

The present disclosure includes optical and functional materials not previously found in pavement marking tapes, including high-index-of-refraction metal oxide materials, quantum light emitting particles, RFID tags, and dichroic pigments. The details of these inclusions will be discussed below.

The structures and methods disclosed herein have particular, but not exclusive, application for pavement marking tapes, and may also be used to mark such features as telephone poles, speed bumps, parking barriers, and other objects which might plausibly be illuminated by artificial spotlights (e.g., headlights) and for which enhanced nighttime visibility presents an aesthetic, communicative, directional, or safety advantage.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. A more extensive presentation of features, details, utilities, and advantages of the present invention as defined in the claims is provided in the following written description of various embodiments and illustrated in the accompanying drawings.

### BRIEF DESCRIPTION OF THE DRAWINGS

FIG. 1 is a cross section view of an exemplary pavement marking tape including raised profile features with advanced retroreflective materials.

FIG. 2 is a cross section view of another exemplary embodiment of a pavement marking tape with raised features coated with advanced retroreflective elements which are held in place with a tinted polymer topcoat.

FIG. 3 is a cross sectional view of an exemplary embodiment of pavement marking tape having quantum dots and dichroic dyes dispersed within a topcoat layer.

FIG. 4A is a schematic view of a roadway with an exemplary embodiment of pavement marking tape in which directionally sensitive dichroic or lenticular markings have been placed.

FIG. 4B is a schematic view of the roadway of FIG. 4A as viewed from the opposite direction as FIG. 4A.

FIG. 5 is a schematic view of a roadway including an exemplary embodiment of pavement marking tape that includes passive transmitting tags that can be remotely sensed.

### DETAILED DESCRIPTION

Typically, road or pavement marking tape is made from a resilient rubber or polymeric base sheet that includes pigment (e.g., titanium dioxide) to provide a white diffuse surface and a blend of organic and inorganic pigments (substituting for lead chromate) to impart a yellow color, as well as inorganic fillers to reduce material costs and also deaden the tape, i.e., reduce rebound. A pattern of protrusions, bosses, or other relief features are formed in the top surface of the pavement marking tape. Retroreflective beads or other particles are bonded to all or portions of the top surface including the bosses with a tinted or pigmented polymer topcoat (colloquially a “paint”, although the topcoat serves multiple structural and environmental functions in addition to its color). Such retroreflective elements are provided to reflect light back to its source (e.g., headlights on a vehicle) with a minimum of scattering. Additionally, other useful particles, such as skid-preventing particles, may be bonded to the top surface of the bosses. An adhesive material layer is further provided to the bottom surface of the tape for adhesion to the pavement or other surface for application. Many different polymers, adhesives, and retroreflectors used in the manufacture of pavement marking tape, and methods of manufacture themselves, are well known in the art and are not described in detail here in order to focus on the primary aspects of this disclosure.

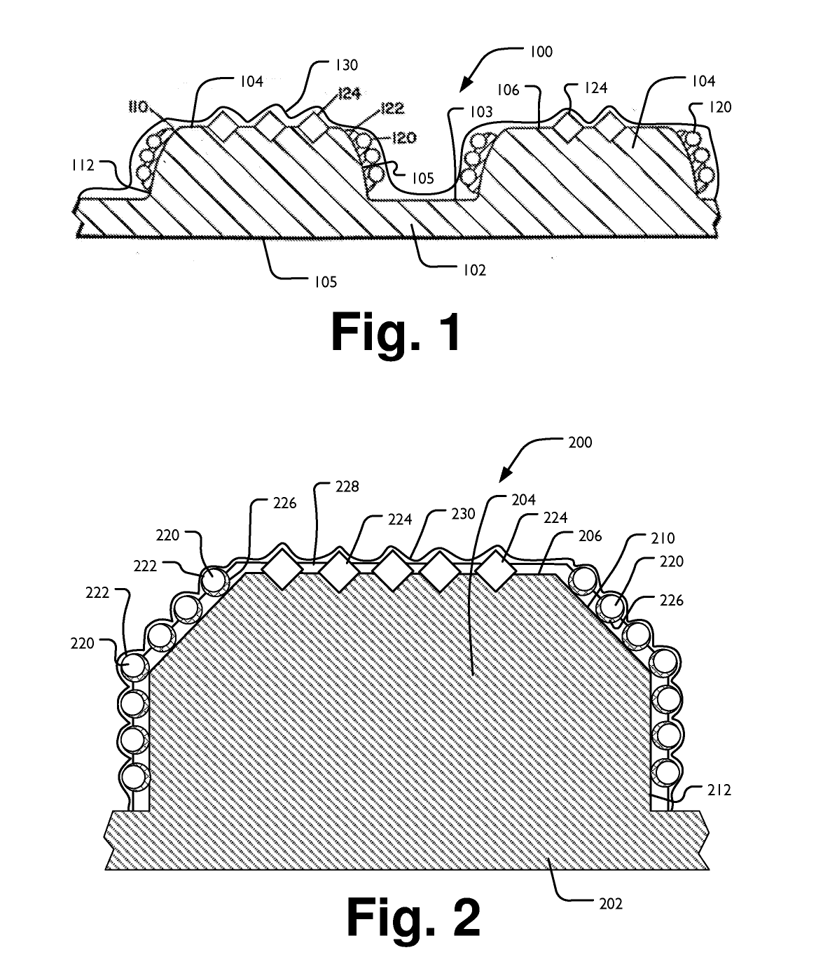

Improvements to known pavement marking tape constitutions are described in the following disclosure. One exemplary implementation of a pavement marking tape 100 is presented in FIG. 1. The tape 100 includes a base 102 and a plurality of raised profile features or protrusions 104. The protrusions 104 may be an integral part of the base sheet 102 and have a top surface 106 and a side surface 108. The protrusions 104 typically have a height between approximately 1-2.5 mm. The base 102 has a front surface 103 from which the protrusions extend and a back surface 105 and typically has a thickness of approximately 0.5-1.0 mm. The side surfaces 108 meet the top surface 106 at a top edge 110. The side surfaces 108 meet the front surface 103 at a lower edge 112. The base 102 may be formed of elastomer precursors, not yet vulcanized or cured, which therefore permit viscoelastic deformation. Exemplary materials are acrylonitrite-butadiene polymers, millable urethane polymers, and neoprenes. Extender resins may be included. Particulate fine-diameter fillers such as silica may be included. Pigments, such as titanium dioxide are preferred in the base 102 to provide a white diffuse surface to uncoated portions of the base 102 and protrusions 104. Another useful pigment is lead chromate which imparts a yellow color. Skid preventing particles 124 such as sand or Al₂O₃ may be partially embedded in the top surface 106 of the protrusions 104. A hydrophobic coating 130 as further described herein may also be applied over the entire surface of the pavement marking tape 100.

Typically, retroreflective beads are attached to the side surfaces 108 of the protrusions 104 using a bond material 122. Retroreflective beads suitable for use are typically glass beads formed of glass materials having indices of refraction (n) from about 1.5 to about 1.9. The glass beads may include a silver or other specular reflective metallic or dielectric coating on the portion of the beads embedded in the adhesive layer. However, in the present implementation, a first group of advanced materials in the form of high-index, high-durability microspheres 120 made of materials other than glass are attached to the side surfaces 108 with the bond material 122. These microspheres 120 are analogous to, and may be substituted for, glass beads.

In some implementations, the microspheres 120 may be made from alumina (e.g., aluminum oxide or sapphire, with an index of refraction of n=1.77), zirconia (n=2.13), and titania (n=2.60) doped with yttrium or yttrium oxide or iron oxide at a level of up to 5 wt % for stability optical clarity. Such doped microbeads are available, for example, from Microspheres-Nanospheres.com. Bismuth titanate (n=2.2) is also a suitable high-index material, available from the same manufacturer.

Suitable material for the bead bond material 122 may be either transparent or opaque, although in a preferred exemplary embodiment transparent, UV curable optical adhesives (e.g., Norland NOA 61, NOA 68, NOA 1315, or NOA 164) may be employed due to their high strength and selectable index of refraction. An opaque adhesive material may be either a thermoplastic or thermosetting polymeric binder. One such binder is a vinyl-based thermoplastic resin including a white pigment, as described in U.S. Pat. No. 4,117,192. Other suitable bead bond materials include two-part polyurethane formed by reacting polycaprolactone diols and triols with derivatives of hexamethylene diisocyanate; epoxy based resins as described in U.S. Pat. No. 4,248,932, U.S. Pat. No. 3,436,359, and U.S. Pat. No. 3,580,887; and blocked polyurethane compositions as described in U.S. Pat. No. 4,530,859. Also suitable as a bead bond material are polyurethane compositions comprised of a moisture activated curing agent and a polyisocyanate prepolymer. The moisture activated curing agent may be an oxazolidene ring. Such compositions are described in U.S. Pat. No. 4,381,388.

One exemplary polyurethane bead bond material 120 is formed by first reacting two equivalents of methylene bis (4-cyclohexyl isocyanate) (H12 MDI) with one equivalent of a polycaprolactone triol of molecular weight about 540 and hydroxyl number about 310 (i.e., a 2-oxypanone polymer with 2-ethyl-2-(hydroxymethyl)1,3propanediol) using dibutyltindilaurate as a catalyst. The reaction is carried out in 2-ethoxyethyl acetate and cyclohexanone. Twenty (20) parts of a 60/40 pigment dispersion of either titanium dioxide or lead chromate in a diglycidyl ether of bisphenol A epoxy resin (e.g., Stan-Tone®10 EPXO3 or 30 EPXO3 made by Harwick Chemical Corp. of Akron, Ohio) may be added to 25 parts of the prepolymer. Zinc 2-ethylhexanoate catalyst is added to the bead bond mixture shortly before application. Inclusion of up to about 10% 2,4 pentanedione in the bead bond extends the pot life of the bead bond 120 from about 1.5 hours to about 15 hours without affecting bead retention.

Another exemplary implementation of a pavement marking tape 200 is presented in FIG. 2 in the context of a single protrusion 204. The tape 200 includes a base 202 and a plurality of raised profile features or protrusions 204. The protrusions 204 may be an integral part of the base sheet 202 and have a top surface 206 and a side surface 208. The side surfaces 208 meet the top surface 206 at a top edge 210. The side surfaces 208 have a lower edge 212 adjacent the base 202. The base 202 may be formed of similar polymers, pigments, fillers, and other materials as described above with respect to the embodiment of FIG. 1. Skid preventing particles 224 such as sand or Al₂O₃ may be partially embedded in the top surface 206 of the protrusions 204. A hydrophobic coating 230 as further described herein may also be applied over the entire surface of the pavement marking tape 200.

As in the embodiment of FIG. 1, a plurality of high-index, high-durability microspheres 220 made of materials other than glass are attached to the side surfaces 208 and top edge 210. In this embodiment, the microspheres 220 are attached to the protrusion 204 by embedding within or coating by a durable topcoat material 228. In an exemplary embodiment, this topcoat material may be a heat-curable, water-based combination of two polyurethane dispersions (PUDs), organic and inorganic, which becomes waterproof once cured. Such materials have been commonly employed in pavement marking tapes for decades. The microspheres 220 may be treated with a functionalized, adhesion coating 222 (e.g., a silane-based coating) that promotes adhesion of the microspheres to the durable topcoat material 202. Optionally, this adhesion coating 222 may be supplemented with a “floatation” coating 226 (e.g., a fluoropolymer coating) of the microspheres 120 such that the microspheres 220 are not completely covered by the topcoat material 228, but tend to be approximately 50-60% covered, regardless of the depth of the topcoat material 228 and the size of the microspheres 220.

Other reflective elements in lieu of or in addition to the microspheres 220 may be made from diamond (n=2.42), or zirconium silicate, with or without a functionalized outer layer. These materials are transparent, and have high indices of refraction that make them particularly suitable as “wet reflective” elements in a pavement marking tape. These materials are also much harder than glass, whereas many high-index materials previously used are softer than glass and are easily scratched, limiting their practical lifespan in the harsh environment of a heavily trafficked road surface.

FIG. 3 is a cross sectional view of a further exemplary implementation of pavement marking tape 300. As depicted in the context of a single protrusion 304, the tape 300 includes a base 302 and a plurality of raised profile features or protrusions 304. The protrusions 304 may be an integral part of the base sheet 302 and have a top surface 306 and a side surface 308. The side surfaces 308 meet the top surface 306 at a top edge 310. The side surfaces 308 have a lower edge 312 adjacent the base 202. The base 302 may be formed of similar polymers, pigments, fillers, and other materials as described above with respect to the embodiment of FIG. 1. The surface of the pavement marking tape 300 is coated or painted with a layer of a hard, environmentally resistant topcoat material 328. A hydrophobic coating 330 as further described herein may also be applied over the entire surface of the pavement marking tape 200.

In the embodiment of FIG. 3, quantum dots 332 and/or dichroic dye molecules 334 or dichroic pigments are dispersed within the topcoat material 328. In various embodiments, the topcoat material 328 may include only quantum dots 332, only dichroic dye molecules 334, or a combination thereof.

The term “quantum dots” as used herein describes any nanoscale particles employed as photoluminescent emitters of light. A quantum dot is a three-dimensional particle having dimensions small enough (typically substantially less than one micron) that excess conduction electrons trapped within it are dominated by their quantum rather than their classical natures. These trapped electrons thus form organized structures and energy levels analogous to the orbitals of an atom, except that adjusting the dimensions and composition of the quantum dot allows for customized orbitals or “artificial atoms” with properties not found in nature. For example the emission and absorption spectra of a quantum dot particle or plurality of particles may be adjusted such that they absorb light at green, blue, violet, and UV wavelengths, and immediately re-emit the absorbed energy as yellow light at a very narrow range of wavelengths. Thus, while materials containing “yellow” quantum dots do not literally glow in the dark, they may appear to glow a bright yellow under even very modest illumination by a white light source or other optical stimulus.

In an exemplary embodiment, quantum dots 332 may be made wholly or predominantly from non-toxic, nonpolluting, environmentally ubiquitous materials such as silicon and carbon. Silicon quantum dots (prepared, for example, by non-thermal plasma synthesis), silicon-germanium quantum dots, “carbon dots,” and “graphene dots” (supplied, for example, by ACS Material) that emit blue, green, red, orange, and yellow light may be used in various embodiments. The emission of green and blue light from such particles has also been demonstrated. These particles may be mixed in with any or all of the reflective elements (e.g., microspheres or glass beads), the skid-enhancing particles (i.e., grit, if present), and the polymer topcoat material 328 (e.g., paint) of the pavement marking tape, such that they emit a desired wavelength of light when stimulated by the white light of vehicle headlights, or other light sources, to enhance the nighttime visibility of the pavement marking tape. In some embodiments this arrangement may also produce a brighter, more vibrant color during daylight. It should also be noted that the absorption and emission of light by these particles may be largely independent of the refractive index of the surrounding medium (i.e., the ambient environment), so the emitted color may appear approximately as bright under a range of both wet and dry environmental conditions.

While it may be convenient to envision the quantum dot particles as approximately spherical objects of a particular size (e.g., a diameter of 10 nanometers) and of uniform composition (e.g., elemental silicon or carbon), it should be understood that the quantum dot particles may have a variety of shapes and sizes; may have one dimension significantly longer than the others (e.g., as a quantum wire); may have two dimensions significantly larger than a third (e.g., a quantum well); may contain a variety of dopants to adjust electrical and optical properties; may have a passivating or chemically reactive shell composed of other materials such as oxides, polymers, and small-molecule ligands (e.g., lipids or polymers); or have other distinguishing characteristics without impairing their function as narrow-spectrum light emitters.

In various embodiments, dichroic dyes or dichroic pigments 334 may be used to present a different color to the viewer depending upon the viewing angle. Dichroic pigments 334 may be either organic or non-organic in composition. Common dichroic pigments include (for example) courmarin yellow, orasol black, and methyl red. Inorganic pigments (including formulations of ethyl 3-ethopropionate, ethyl 3-ethoxonepropionate, ethyl 3-ethoxypropionate, mica, and talc) may be more stable during prolonged exposure to heat and UV and may therefore be preferable for use in pavement marking tapes 300. The production of pavement marking tapes 300 may include a paint or polymer application process that inherently draws material in a particular direction (e.g., gravure coating) in a manner similar to a comb. Because dichroic molecules or particles are generally rod-shaped (long and skinny), this same drawing process may be used to align dichroic pigment particles or molecules in the paint or polymer as it is being applied, either by themselves or in accompaniment with larger “host” molecules, in a manner similar to aligning hair strands by drawing a comb along them

Alternatively, the dichroic pigments may be aligned during manufacture by a magnetic or electric field, by a temperature gradient, or the pigments may be pre-aligned in a layer of dichroic polymer film that is incorporated into the pavement marking tape. This also allows for the possibility of lenticular films that present a particular detailed, printed image from one viewing angle or series of viewing angles, and a different image from a different viewing angle. Such lenticular films may be incorporated as a separate layer, for example, on the tops of the profile bumps, on in the valleys between them, or both. Such a lenticular film may also or alternatively be placed on top of and may reshape and conform to the bumps in the rubber tape, or may be “painted” or “registered” in such a way that the ridges of the lenticular image coincide with the bumps on the rubber tape.

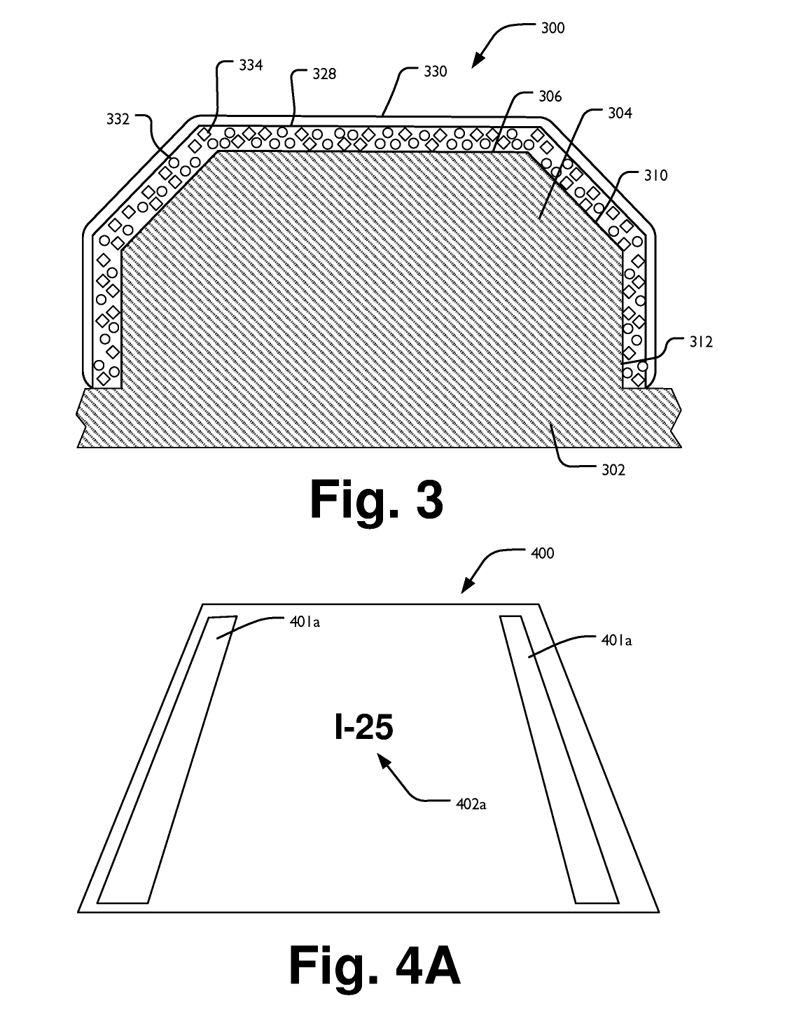

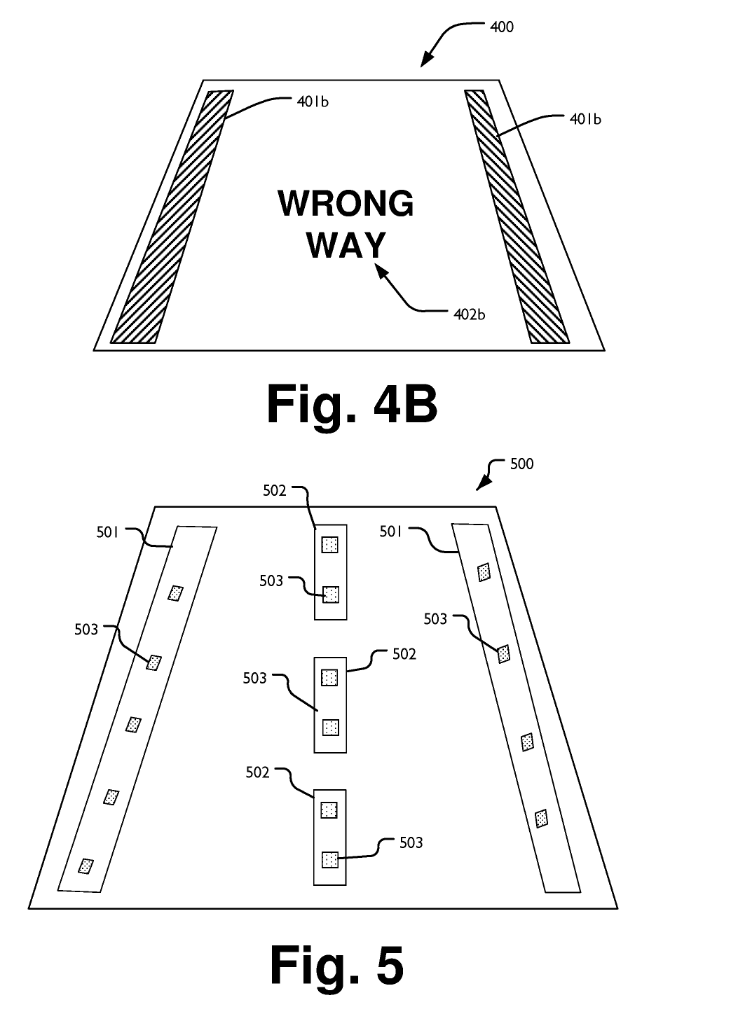

FIGS. 4A and 4B are schematic views of a pavement 400 marked with dichroic pigments or lenticular images, such that a traveler facing one direction sees For example, pavement marking lines 401a as viewed from a first direction may appear as a non-alarming color (typically yellow or white) as suggested in FIG. 4A, but which appear in a more alarming color (e.g., orange or red) as the pavement marking lines 401b are viewed from an opposing direction as indicated in FIG. 4B. Similarly, portions of the tape may spell out letters or symbols that are different in one travel direction than in the other, e.g., a stylized interstate highway symbol and number 402a (e.g., 1-25) in one direction as shown in FIG. 4A, and a different indicator 402b, e.g., “WRONG WAY”, in the other as shown in FIG. 4B. in an alternative embodiment, dichroic pigments or lenticular images in a pavement marking tape may be used to provide an indicator that appears white or yellow, but upside down and backward to a driver proceeding in the proper direction on a highway, but which appear in the correct direction and possibly in a warning color (e.g., red) to a driver proceeding in the wrong direction, or approaching an off-ramp from the wrong direction.

Both dichroic pigments and lenticular images are capable of showing a particular color in a narrow range of viewing angles, and a different color in a different range of viewing angles. Another exemplary use may be range-indicating tapes that, for example, reflect more brightly to a driver within a particular range (e.g., within 50 meters), and less brightly to a driver outside that range, such that the visual clutter of distant objects is minimized and the visual cues of the road marking tape appear most prominently when they are most relevant to a driver. For example, a dichroic or lenticular pavement marking tape could be optimized such that it is most reflective (or most white in color, thus affecting its perceived brightness) at a viewing angle of 1.55° or 0.95°, thus affecting the range at which it appears brightest. For reference, at the time of this writing retroreflectivity measurements (as defined by ASTM D4505 and other measurement standards in widespread use) are taken at an observation angle of 1.05°.

Optionally, the traveler may also see other pavement markings such as text, arrows, or symbols of non-alarming colors including yellow, white, black, and blue, either singly or in combinations (e.g., made to resemble a highway identification sign or other informative sign). Specifically, these markings may reassure the driver that he or she is on the correct side of the road, traveling in the correct direction, or otherwise obeying the rules or intended use of a paved environment such as a road or parking lot. However, a traveler facing the other direction sees pavement marking lines of an alarming color or color pattern (e.g., solid red lines, or red and white striped lines, or black and yellow striped lines) indicating a hazard. Optionally, the traveler may also see other pavement markings 604 such as text, arrows, or symbols of alarming colors (including red and orange) or color combinations (including red-and-white, yellow-and-black, or yellow-and-orange) indicating a hazard. Specifically, these “hazard” markings may indicate that the traveler is heading the wrong way down a road or parking lot, or entering through an off-ramp, or otherwise violating traffic rules or is performing or about to perform an unsafe action.

In various embodiments described above, a hydrophobic coating (130, 230, 330) may optionally be applied to the surface of the pavement marking tape (100, 200, 300), including on top of the environmentally resistant topcoat material (228, 328), covering both the profile features or “bumps” (protrusions 104, 204, 304) and the spaces between the profile features, or “valleys”, such that the surface of the road marking tape repels water and remains relatively dry, even under conditions of heavy rain. Additionally, the pavement marking tape may drain and dry more quickly than the surrounding pavement once the rain has ceased. This may allow the pavement marking tape to retain dry reflectivity characteristics for a greater percentage of time, and to exhibit wet reflectivity characteristics for a minimal percentage of time, thus improving the overall visibility of the pavement marking tape over time.

In various embodiments, the hydrophobic coating may consist of a mixture of two components. The first component may be a curable, water-based polymer resin consisting predominantly of either polyeurethane or acrylic that is chemically functionalized such that when initially dissolved in water the material can easily be coated onto flat or contoured surfaces. When the water evaporates and heat is applied, the material cures into a solid, waterproof polymer that may serve, for example, as a component of paints or topcoats.

The second component may be a silicone polymer that may serve, for example, as a slip agent or release agent on an adhesive coating line. When tapes incorporating a strong adhesive are rolled up, the adhesive side of the tape may bond strongly to the non-adhesive side, making it difficult to unroll the tape without damaging it. Therefore, a release agent may be coated onto the non-adhesive side, such that the adhesive cannot stick strongly to it. In one embodiment, the release agent adheres well enough to the non-adhesive side that it does not pull away and contaminate the adhesive side. However, such materials are not typically durable in the face of temperature extremes, UV exposure, tire strikes, and rain. As a result, when release coatings are used on pavement marking tapes, they may wear off the surface of the pavement marking tape within a few days or weeks of the tapes' application to a pavement surface.

As noted above, the slip agent can be hydrophobic and the curable resin can be durable. Mixtures of thermally curable acrylic or polyeurethane emulsions along with thermally curable polysiloxane polymer emulsions may be both sufficiently durable and sufficiently hydrophobic to provide long-term improvement in the visibility of the pavement marking tape under wet conditions. Both materials are water soluble before curing, and the dry thickness of the final, cured coating is a function of the wet coating thickness and the percent solids of the emulsion. The solids themselves consist of 20-80% acrylic or polyurethane resin with the remainder being polysiloxane, with a preferred embodiment consisting of a 50-50 mixture.

In one exemplary embodiment, the hydrophobic coating is applied on top of the durable topcoat material layer in a thickness of between 25 microns and 250 microns. However, the hydrophobic coating may also be thinner or thicker than this, or the hydrophobic coating may be used in place of, or in a blended mixture with, the durable topcoat material layer.

FIG. 5 is a schematic view of a marked pavement 500, with pavement marking tape “long lines” 501 and “skip lines” 502 marking the edges and center of the pavement, respectively. As shown, the pavement marking tapes 501, 502 contain RFID tags or other passive, machine-readable markers 503 that emit a clearly identifiable signal when excited with long-wavelength radiation (e.g., radio waves or microwaves), whether ambient or deliberately emitted by a passing vehicle or other apparatus.

Although vehicle navigation systems have proven adept at identifying and responding to visible markings on the pavement, these markings are not visible when covered by snow, or when heavy snow, dust, smoke, or other obscurants in the atmosphere reduce visibility to less than a safe reaction distance

Adhesive-backed, ultra-high frequency (UHF) RFID tags, of the sort used for product marking and other related applications, are widely available at very low cost (e.g., from ZIH Corporation). However, liquid water may interfere with the UHF RFID signal, such that the pavement marking tape may thus have limited UHF “visibility” under heavy rain conditions. Accordingly, in some implementations, other portions of the RF spectrum may be employed which do not suffer such reduced “visibility” in rainy or wet conditions. The tags have no power supply of their own, but are excited by an external RF signal and emit an RF signal in return that can be detected by a compact reading apparatus within a radius of at least 3 meters (depending on the strength of the exciting signal, the sensitivity of the receiving antenna, and the versatility of the decoding algorithm). Equipment for reading UHF RFID tags is widely available, and may be incorporated into vehicle navigation and control systems in a variety of different ways such that the position and orientation of the pavement marking tape can be deduced with sufficient accuracy to aid in vehicle navigation. The tag itself includes a flexible, 2D printed circuit for modulating and demodulating the RF signal and converting RF energy into power; and a flexible, 2D antenna for receiving and transmitting the signal. These circuits may be printed onto a flexible substrate with an adhesive backing.

Such tags may be incorporated into the pavement marking tape by, for example, affixing them to the bottom of the tape surface (or to a fabric scrim located thereon) with a roll applicator before the pavement-binding adhesive is coated or laminated onto it, such that the tags are located between the tape and the pavement and are thus protected from environmental insults such as moisture and abrasion. In one exemplary embodiment, the tags are placed with a spacing of not more than 14.6 feet, such that a vehicle traveling at 10 miles per hour under low-visibility conditions will encounter at least one tag per second of elapsed time. However, other spacings between tags may also be employed to account for different vehicle speeds and driving conditions. The exact hardware employed on passing vehicles to excite, interrogate, read, interpret, or respond to the RFID tags need not be constrained. Similarly, the exact signal, message, wavelength, encoding scheme, or bandwidth of the signals emitted by the RFID tags incorporated into the pavement marking tape can be selected from any of a number of protocols. In exemplary embodiments, the exciting/receiving hardware located on the vehicles may be capable of detecting a wide variety of different RFID tags and signals, whether presently in existence or hereinafter developed. In effect, the content of the signal may even be partially or completely ignored, whereas the mere existence of one or more RFID signals may be used to deduce the vehicle's position on the roadway by signal-strength triangulation, time-of-flight triangulation, or by other related techniques (e.g., Kalman filtering). This information may then be employed by either a robotic driving system or directed to the attention of a human driver (e.g., via a heads-up display).

Analogously, the human eye detects pavement marking tapes (and other pavement markings) without particular regard to their width, length, height, thickness, hue, brightness, retroreflectivity, or other specific visual properties, and the navigation and guidance systems of the human brain nevertheless control the vehicle to remain within the specified lanes, even in cases where some markings may be confusing, partially obscured, damaged or absent. It is similarly intended that “smart vehicle” systems may employ the RFID signals of the marking tape in a robust manner, including as an adjunct to other navigational inputs including, but not limited to, GPS, machine vision, inertial navigation, cell tower and WiFi-based navigation. The road marking tape merely supplies the RFID infrastructure which reader technologies (excitement by RF emitters and detection by RF receivers) may detect and employ as navigational aids, in effect making the pavement marking tapes “visible” in the RF spectrum as well as the visible spectrum (excited by ambient light and/or headlights and detected by visible-light camera systems or by human eyes).

However, in certain embodiments it may be desirable to employ RFID tags with particular (e.g., standardized) range and signal strength properties in order to reduce or optimize the hardware requirements or computational burden on a particular RFID-aided navigation system. Alternatively, the pavement marking tape may be populated with a heterogeneous mix of different RFID tags, so as to maximize the probability of detection of the pavement marking tape by a variety of different (e.g., non-standardized) navigation hardware.

Although the figures represent only particular exemplary embodiments, it is intended that the pattern shown is exemplary rather than limiting. For example, the specific number, density, arrangement, orientation, and distribution of high-index reflective elements 120, 220, quantum dots 332, dichroic pigments 334, and passive, machine-readable transmitting tags 503 may be different than shown herein without departing from the scope of the present disclosure.

Other variations are also possible. For example, the pavement marking tape may be a durable or permanent tape intended to remain in place for many years after installation on a pavement surface. Alternatively, the pavement marking tape may be a temporary or removable tape intended to be removed after a period of a few months or even a few days, as with the markings for a construction zone or special event. The difference between a temporary (or removable) and a permanent (or durable) tape is generally defined by the peel strength of its adhesive and the flowability/conformability of its rubber composition (typically a polyethylene, polyvinylchloride, or polybutadiene based material), but could also be defined, for example, by the weave dimensions of an attached fabric “scrim” that sits between the base of the pavement marking tape and the adhesive, by the chemical or mechanical properties of a “primer” compound applied to the pavement before the application of the tape, by the specific properties of a particular paving surface (e.g., a polished concrete floor of a garage as opposed to asphalt), or by the tear strength of the pavement marking tape (e.g., higher for a removable tape).

In addition, it should be understood that the pavement marking tape may be bonded to asphalt pavement of various grades and consistencies, or it could be bonded to concrete of various types and including mixes having various additives and fillers. In addition, the pavement marking tape may be applied to non-pavement surfaces such as walls, doors, floors, other building surfaces, signage, parking barriers, traffic barriers, utility poles, and even vehicles. As such, the pavement marking tape may be bonded to a vast assortment of other materials to provide a high degree of retroreflectivity.

Furthermore, while the width of a traditional highway tape is typically about 4″ (10 cm), the retroreflective tape disclosed herein may be produced in any width, for example, to be used in crosswalk features or to mark words, symbols, or directional arrows on the pavement, or for other reasons presently anticipated or otherwise. Similarly, while the thickness of pavement marking tapes is typically between 40 and 80 mils (1.0-2.0 mm), the pavement marking tape as disclosed herein may be produced in any thickness as dictated by the needs of cost, manufacturing, installation, removal, and the particularities of the environment of intended use.

Still other variations are possible. The mixture bonded to the surface of the pavement marking tape may include traction-improving grit as well as retroreflective beads and pigment. The pavement marking tape may further include a “slip” coating to help end users unwind it from the roll, and/or an environmental overcoat to help keep the beads in place when tire hits and other environmental insults occur, or to improve the protection against rain, humidity, UV, cold, or heat. The pavement marking tape may also include a metal foil layer to enhance reflectivity, or a paper layer to allow the pavement marking tape to be removed from the pavement surface with a torch. The pavement marking tape may be white or yellow (the most common pavement marking colors), but may also be black, orange, red, blue, or any other desired color. The pavement marking tape may be striped or otherwise multicolored, and may include text, symbols, or other markings. The pavement marking tape may be placed on the pavement manually, or with a hand-pushed automatic cart, or by a specialized applicator vehicle. The pavement marking tape may be manufactured, shipped, or sold in jumbo rolls of 1000 m or more, or in smaller rolls, or it may be available in sheet or strip form.

In this document, all directional references e.g., proximal, distal, upper, lower, inner, outer, upward, downward, left, right, lateral, front, back, top, bottom, above, below, vertical, horizontal, clockwise, and counterclockwise are only used for identification purposes to aid the reader's understanding of the present invention, and do not create limitations, particularly as to the position, orientation, or use. Connection references, e.g., attached, coupled, connected, and joined are to be construed broadly and may include intermediate members between a collection of elements and relative movement between elements unless otherwise indicated. As such, connection references do not necessarily imply that two elements are directly connected and in fixed relation to each other. Stated values shall be interpreted as illustrative only and shall not be taken to be limiting.

The above specification, examples and data provide a complete description of the structure and use of exemplary embodiments of the invention as defined in the claims. Although various embodiments of the claimed invention have been described above with a certain degree of particularity, or with reference to one or more individual embodiments, those skilled in the art could make numerous alterations to the disclosed embodiments without departing from the spirit or scope of the claimed invention. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of as defined in the following claims.

What is claimed is:

1. A surface marking tape comprising
a substantially flat tape substrate;
a plurality of protrusions extending from a surface of the flat tape substrate;
a plurality of retroreflective, non-glass microspheres with a high index of refraction provided on at least one surface of each of the plurality of protrusions; and
an adhesive material layer coupling the plurality of microspheres to the at least one surface of the plurality of protrusions.

2. The surface marking tape of claim 1, wherein the plurality of microspheres are formed from at least one of alumina, sapphire, aluminum oxide, zirconia, titania, and bismuth titanate.

3. The surface marking tape of claim 2, wherein the microspheres are formed from titania doped with at least one of yttrium, yttrium oxide, or iron oxide.

4. The surface marking tape of claim 1, wherein the microspheres have an index of refraction of at least 1.7.

5. The surface marking tape of claim 1, further comprising at least one dichroic element configured to reflect a first color when observed from a first range of angles of view and to reflect a second color different than the first color when observed from a second range of angles of view.

6. The surface marking tape of claim 1, wherein
the protrusions have a top surface and side surfaces extending between the flat tape substrate and the top surface; and
the microspheres are provided on the side surfaces of the plurality of protrusions.

7. The surface marking tape of claim 1, wherein the plurality of microspheres have a floatation coating applied to at least portions of surfaces of the microspheres.

8. The surface marking tape of claim 1, wherein the adhesive material layer is a durable topcoat for the surface marking tape.

9. The surface marking tape of claim 1 further comprising passive, machine-readable, markers incorporated within the surface marking tape.

10. The surface marking tape of claim 9, wherein the passive machine-readable transmitting markers are radio frequency identification tags configured to emit radio-frequency signals.

11. A surface marking tape comprising
a substantially flat tape;
a plurality of protrusions extending from a surface of the flat tape;
a plurality of high-visibility, photoluminescent emitters provided on at least one surface of each of the plurality of protrusions;
an adhesive coupling the plurality of high visibility elements to the plurality of protrusions.

12. The surface marking tape of claim 9, wherein the photoluminescent emitters are quantum dots.

13. The surface marking tape of claim 11, wherein the photoluminescent emitters are formed of one or more of silicon, carbon, or graphene materials.

14. The surface marking tape of claim 13 further comprising a dichroic pigment coupled by the adhesive to the plurality of protrusions.

15. The surface marking tape of claim 14, wherein the adhesive is a durable topcoat material.

16. The surface marking tape of claim 15, wherein the durable topcoat material further comprises a pigment.

17. The surface marking tape of claim 9, wherein the photoluminescent emitters emit light in a predetermined wavelength range.

18. The surface marking tape of claim 17, wherein absorption and emission of light by the photoluminescent emitters is substantially independent of a refractive index of a surrounding medium, so the emitted light appears substantially as bright over a range ambient environmental conditions.

19. The surface marking tape of claim 12, wherein the dichroic pigment is aligned within the adhesive to create lenticular images that have different patterns based on an angle of view.

20. The surface marking tape of claim further comprising radio frequency identification tags adhered to a bottom surface the surface marking tape.
